(19) United States
(12) Patent Application Publication
(10) Pub. No.: US 2026/0351834 A1
(43) Pub. Date: Nov. 5, 2026

(54) SPACING ELEMENTS FOR ANTENNAS OF HEARING INSTRUMENTS

(71) Applicant: Starkey Laboratories, Inc., Eden Prairie, MN (US)

(72) Inventors: Carter Christensen, Prior Lake, MN (US); Seyednaser Mousavi, Eden Prairie, MN (US); Ashutosh Mehra, St. Paul, MN (US); Darin Glen Jensen, Savage, MN (US); Kurt G. Koubal, Minnetonka, MN (US)

(21) Appl. No.: 19/637,686

(22) Filed: Apr. 2, 2026

Related U.S. Application Data
(60) Provisional application No. 63/797,510, filed on Apr. 30, 2025.

(51) Int. Cl. H01Q 1/22; H01Q 1/40; H01Q 7/00; H04R 25/00

(52) U.S. Cl. CPC H01Q 1/22; H01Q 1/40; H01Q 7/00; H04R 25/602; H04R 2225/51

(57) ABSTRACT

A hearing instrument comprising: a battery that is substantially cylindrical and has a first end and a second end; an antenna comprising an antenna element; a spacing element disposed between the antenna element and at least one of: the first end of the battery or a battery conductor connected to the first end of the battery; and a conformal coating that covers exposed surfaces of the antenna element, the spacing element, and the battery, wherein an air gap is present between at least a portion of the spacing element and the first end of the battery.

This application claims the benefit of U.S. Provisional Patent Application 63/797,510, filed Apr. 30, 2025, the entire content of which is incorporated by reference.

### TECHNICAL FIELD

This disclosure relates to antennas for hearing instruments.

### BACKGROUND

Wearable devices are devices designed to be worn on, in, or near a user’s body. Example types of wearable devices may include hearing instruments, smart watches, on-body biometric sensors, media players, augmented or virtual reality headwear, and so on. Hearing instruments are wearable devices designed to be worn on, in, or near one or more of a user’s ears. Common types of hearing instruments include hearing assistance devices (e.g., “hearing aids”), earbuds, headphones, hearables, cochlear implants, and so on. In some examples, a hearing instrument may be implanted into a user. Some hearing instruments include additional features beyond sound-amplification. For example, some modern hearing instruments include advanced audio processing for improved device functionality, controlling and programming the devices, and beamforming, and some can even communicate wirelessly with external devices including other hearing instruments (e.g., for streaming media).

### SUMMARY

This disclosure describes antenna designs for hearing instruments. As described in this disclosure, a hearing instrument includes a battery and an antenna. At least a portion of an antenna element of the antenna overlaps a terminal of the battery. Application of a parylene coating may protect the antenna and other components of the hearing instrument. However, application of the parylene coating may cause adhesion of the antenna to the battery or warping of the antenna. Adhesion of the antenna to the battery or warping of the antenna toward the battery may increase a capacitive load of the antenna. This may reduce antenna performance. In accordance with one or more techniques of this disclosure, spacing elements are positioned between the antenna element and the battery. The presence of such spacing elements may prevent or reduce such adhesion or warping.

In one example, this disclosure describes a hearing instrument comprising: a battery that is substantially cylindrical and has a first end and a second end; an antenna comprising an antenna element; a spacing element disposed between the antenna element and at least one of: the first end of the battery or a battery conductor connected to the first end of the battery; and a conformal coating that covers exposed surfaces of the antenna element, the spacing element, and the battery, wherein an air gap is present between at least a portion of the spacing element and the first end of the battery facing the antenna element.

The details of one or more aspects of the disclosure are set forth in the accompanying drawings and the description below. Other features, objects, and advantages of the features and techniques described in this disclosure will be apparent from the description, drawings, and claims.

### BRIEF DESCRIPTION OF DRAWINGS

FIG. 1 is a conceptual diagram illustrating an example system that includes one or more hearing instruments, in accordance with one or more aspects of this disclosure.

FIG. 2 is a block diagram illustrating example components of a hearing instrument, in accordance with one or more aspects of this disclosure.

FIG. 3 is a conceptual diagram illustrating an example hearing instrument with a disk-shaped spacing element, in accordance with one or more techniques of this disclosure.

FIG. 4 is a conceptual diagram illustrating an example hearing instrument with a disk-shaped spacing element, in accordance with one or more techniques of this disclosure.

FIG. 5 is a conceptual diagram illustrating an example hearing instrument with a disk-shaped spacing element, in accordance with one or more techniques of this disclosure.

FIG. 6 is a conceptual diagram illustrating an example hearing instrument with a rectangular spacing element, in accordance with one or more techniques of this disclosure.

FIG. 7 is a conceptual diagram illustrating an example hearing instrument with a rectangular spacing element, in accordance with one or more techniques of this disclosure.

FIG. 8 is a conceptual diagram illustrating an example hearing instrument with a square spacing element, in accordance with one or more techniques of this disclosure.

FIG. 9 is a conceptual diagram illustrating an example hearing instrument with a square spacing element, in accordance with one or more techniques of this disclosure.

FIGS. 10A-10C are conceptual diagrams illustrating cross-section views of example hearing instruments with spacing elements, in accordance with one or more techniques of this disclosure.

FIG. 10D illustrates a cross-section plane applied with respect to FIGS. 10A, 10B, and 10C.

FIG. 11 is a conceptual diagram illustrating an example hearing instrument with an X-shaped spine spacing element, in accordance with one or more techniques of this disclosure.

FIG. 12 is a conceptual diagram illustrating an example hearing instrument with a second X-shaped spine spacing element, in accordance with one or more techniques of this disclosure.

FIG. 13 is a conceptual diagram illustrating an example hearing instrument with a T-shaped spine spacing element, in accordance with one or more techniques of this disclosure.

FIG. 14A is a conceptual diagram illustrating an example hearing instrument with a reduced overlap between an antenna element and a battery, in accordance with one or more techniques of this disclosure.

FIG. 14B is a conceptual diagram illustrating an example hearing instrument with a reduced overlap between an antenna element and a battery, in accordance with one or more techniques of this disclosure.

FIG. 15A is a conceptual diagram illustrating an example hearing instrument with a perforated antenna element, in accordance with one or more techniques of this disclosure.

FIG. 15B is a conceptual diagram illustrating an example hearing instrument in which an antenna element defines a window, in accordance with one or more techniques of this disclosure.

FIG. 16 is a conceptual diagram illustrating an example hearing instrument in which an antenna element defines digitated slots, in accordance with one or more techniques of this disclosure.

FIG. 17 is a conceptual diagram illustrating an example hearing instrument in which protrusions of a spine are used to support an antenna element, in accordance with one or more techniques of this disclosure.

FIG. 18 is a flowchart of an example process for assembling a hearing instrument, in accordance with one or more techniques of this disclosure.

FIGS. 19A, 19B, and 19C are conceptual diagrams illustrating example spacing elements that define one or more internal openings.

### DETAILED DESCRIPTION

Wireless communication links are becoming an increasingly common aspect of wearable devices, such as hearing instruments. A hearing instrument may use wireless communication links to communicate with other hearing instruments or with other types of devices, such as mobile phones or hearing instrument accessories. Such communication may serve a wide variety of purposes, such as streaming media data and sending sensor data.

A hearing instrument includes a battery that provides electrical energy to components of the hearing instrument. Additionally, the hearing instrument includes an antenna to perform wireless communication. The hearing instrument is designed such that there is an air gap between antenna elements of the antenna and terminals of the battery and battery conductors. The air gaps reduce or eliminate interaction between the antenna and the battery.

A parylene coating may be applied to the battery and antenna after assembly of the battery and antenna to a spine of the hearing instrument, such as a receiver in canal (RIC) hearing instrument or other types of hearing instruments. The parylene coating may provide environmental protection. That is, the parylene coating may protect the battery and antenna from moisture, dust, and extreme temperatures. However, the parylene coating may cause an adhesion between the battery and the antenna, creating a new layer of dielectric, with higher dielectric permittivity, between a conductor of the antenna and a conductor of the battery. The increase in the dielectric permittivity increases capacitive loading in the antenna. Additionally, the adhesion of the antenna to the battery may, in some cases, create a vacuum effect that can physically warp the antenna so that a portion of the antenna is closer in distance to the battery than intended. This reduced distance may increase capacitive loading in the antenna. Thus, as a result of application of the parylene coating, a significant degradation of the total received power (TRP) of the signal emitted by the antenna is observed. In some instances, the degradation is on an order of 5-7 dB. This problem is exacerbated by the use of thicker or wider batteries, which may have the advantage of greater energy storage but have the effect of reducing the air gap between the antenna and the battery or battery conductors. In some examples, degradation on an order of 5-6 dB has been observed due to larger or thicker batteries. This reduced air gap may further increase capacitive loading in the antenna. Similarly, the use of batteries with greater diameters leads to an increase in an area occupied by a battery conductor, which increases capacitive loading in the antenna. In examining an equation for a capacitor, there are three degrees of freedom: the distance between the conductors, the area of the conductors, and the dielectric permittivity of the material between the conductors.

This disclosure describes techniques that may address these problems. This disclosure presents solutions to the problems above as they relate to variables of capacitive loading. As described herein, spacing elements are disposed between one or more antenna elements of an antenna of a hearing instrument and one or more ends of a battery of the hearing instrument and/or battery conductors connected to the one or more ends of the battery. These spacing elements may reduce or eliminate adhesion between the antenna and the ends of the battery and/or the battery conductors. Additionally, the spacing elements may reduce the physical warping of the antenna. Thus, in some examples, a hearing instrument comprises a battery that is substantially cylindrical and has a first end and a second end (e.g., a first terminal and a second terminal). The hearing instrument may further comprise an antenna that includes an antenna element. The hearing instrument also includes a spacing element disposed between the antenna element and at least one of: the first end of the battery or a battery conductor connected to the first end of the battery. A conformal coating may cover exposed surfaces of the antenna element, the spacing element, and the battery. The exposed surfaces are surfaces that are not in direct contact with another surface. An air gap may be present between at least a portion of the spacing element and the first end of the battery and/or the battery conductor. Inclusion of the air gap may help with manufacturability. For example, less precision may be required in placement of the spacing element when the spacing element is smaller in one or more dimensions than the end of the battery. In this example, the battery may be recessed into a cavity of the spine. Thus, if the spacing element is as large or close to as large as the battery, it becomes more likely that an edge of the spacing element will overlap a lip of the cavity instead of sitting flush with the battery. Thus, the spacing element may stack up on the spine which may prevent the antenna or other components from being correctly positioned. In some examples, multiple separate spacing elements may be present between the antenna element and the same end of the battery. This may be a benefit from a redundancy standpoint. If one spacing fails, there are multiple backups. Including multiple spacing elements between the antenna element and the end of the battery may also be a benefit if it allows more air gaps leading to lower dielectric permittivity.

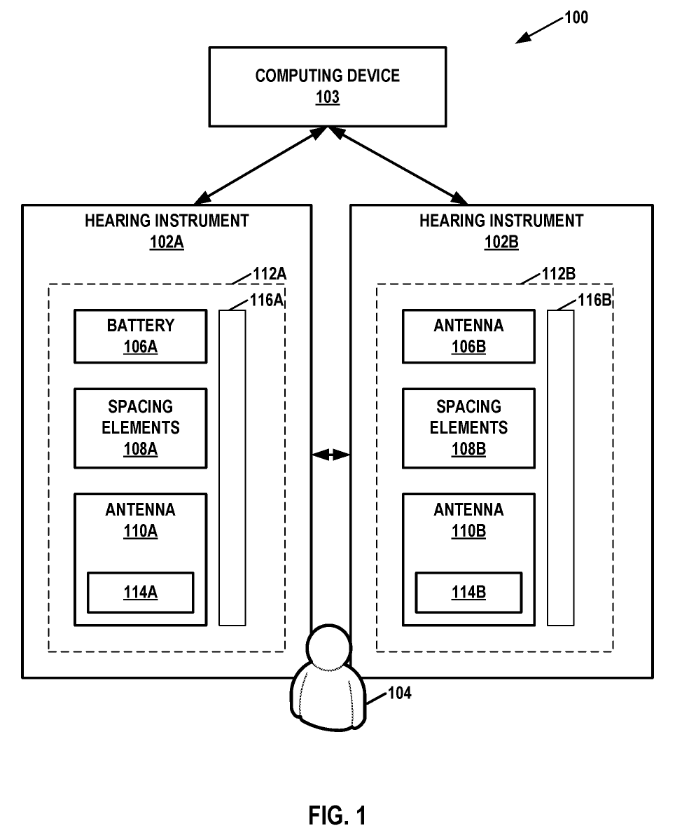

FIG. 1 is a conceptual diagram illustrating an example system 100 that includes hearing instruments 102A, 102B, in accordance with one or more aspects of this disclosure. This disclosure may refer to hearing instruments 102A and 102B collectively, as “hearing instruments 102.” A user 104 may wear hearing instruments 102. In some instances, user 104 may wear a single hearing instrument. In other instances, the user may wear two hearing instruments, with one hearing instrument for each ear of user 104.

Hearing instruments 102 may comprise one or more of various types of devices that are configured to provide auditory stimuli to user 104 and that are designed for wear and/or implantation at, on, or near an ear of user 104. Hearing instruments 102 may be worn, at least partially, in the ear canal or concha. One or more of hearing instruments 102 may include behind the ear (BTE) components that are worn behind the ears of user 104. In some examples, hearing instruments 102 comprise devices that are at least partially implanted into the skull of user 104. In some examples, one or more of hearing instruments 102 provide auditory stimuli to user 104 via a bone conduction pathway.

In any of the examples of this disclosure, each of hearing instruments 102 may comprise a hearing assistance device. Hearing assistance devices include devices that help a user hear sounds in the user’s environment. Example types of hearing assistance devices may include hearing aid devices, Personal Sound Amplification Products (PSAPs), cochlear implant systems (which may include cochlear implant magnets, cochlear implant transducers, and cochlear implant processors), and so on. In some examples, hearing instruments 102 are over-the-counter, direct-to-consumer, or prescription devices. Furthermore, in some examples, hearing instruments 102 include devices that provide auditory stimuli to user 104 that correspond to artificial sounds or sounds that are not naturally in the environment of user 104, such as recorded music, computer-generated sounds, or other types of sounds. For instance, hearing instruments 102 may include so-called “hearables,” earbuds, earphones, or other types of devices. Some types of hearing instruments provide auditory stimuli to user 104 corresponding to sounds from the environment of user 104 and also artificial sounds.

In some examples, one or more of hearing instruments 102 may be in-the-ear (ITE) devices, which include a housing worn within the concha and cymba concha. In some examples, one or more of hearing instruments 102 may be in-the-canal (ITC) devices, which include a housing worn primarily within the concha. In some examples, one or more of hearing instruments 102 may be completely-in-canal (CIC) devices, which include a housing worn primarily within an external portion of the auditory canal. In ITE, ITC, and CIC hearing instruments, a receiver that generates sound is included within the housing of the hearing instruments.

Hearing instruments 102 may implement a variety of features that help user 104 hear better. For example, hearing instruments 102 may amplify the intensity of incoming sound, amplify the intensity of certain frequencies of the incoming sound, attenuate certain frequencies, and/or translate or compress frequencies of the incoming sound. In another example, hearing instruments 102 may implement a directional processing mode in which hearing instruments 102 selectively amplify sound originating from a particular direction (e.g., to the front of the user) while potentially fully or partially canceling sound originating from other directions. In other words, a directional processing mode may selectively attenuate off-axis unwanted sounds. The directional processing mode may help users understand conversations occurring in crowds or other noisy environments. In some examples, hearing instruments 102 may use beamforming or directional processing cues to implement or augment directional processing modes.

In some examples, hearing instruments 102 may reduce noise by canceling out or attenuating certain frequencies. Furthermore, in some examples, hearing instruments 102 may help user 104 enjoy audio media, such as music or sound components of visual media, by outputting sound based on audio data wirelessly transmitted to hearing instruments 102.

Hearing instruments 102 may be configured to communicate with each other. For instance, in any of the examples of this disclosure, hearing instruments 102 may communicate with each other using one or more wireless communication technologies. Example types of wireless communication technology include Near-Field Magnetic Induction (NFMI) technology, a 2.4 gigahertz (GHz) technology, a BLUETOOTH™ technology, Bluetooth Low Energy (BLE), a WI-FI ™ technology, audible sound signals, ultrasonic communication technology, infrared communication technology, an inductive communication technology, or another type of communication that does not rely on wires to transmit signals between devices. In some examples, hearing instruments 102 use a 2.4 GHz frequency band for wireless communication.

As shown in the example of FIG. 1, system 100 may also include a computing device 103. In other examples, system 100 does not include computing device 103. Computing device 103 may comprise one or more mobile devices, server devices, personal computer devices, handheld devices, wireless access points, smart speaker devices, smart televisions, medical alarm devices, smart key fobs, smartwatches, smartphones, motion or presence sensor devices, smart displays, screen-enhanced smart speakers, wireless routers, wireless communication hubs, prosthetic devices, mobility devices, special-purpose devices, accessory devices, and/or other types of devices. Accessory devices (not shown in FIG. 1) may include devices that are configured specifically for use with hearing instruments 102. Example types of accessory devices may include charging cases for hearing instruments 102, storage cases for hearing instruments 102, media streamer devices, phone streamer devices, external microphone devices, remote controls for hearing instruments 102, and other types of devices specifically designed for use with hearing instruments 102. One or more of hearing instruments 102 may communicate with computing device 103 using wireless or non-wireless communication links. For instance, hearing instruments 102 may communicate with computing device 103 and/or each other using any of the example types of communication technologies described elsewhere in this disclosure. For example, hearing instruments 102 may communicate with computing device 103 and/or each other using antennas conforming to the antenna designs described in this disclosure.

In the example of FIG. 1, hearing instrument 102A includes a battery 106A, one or more spacing elements 108A and an antenna 110A. Hearing instrument 102B includes a battery 106B, one or more spacing elements 108B, and an antenna 110B. Hearing instruments 102 may include components in addition to those shown in the example of FIG. 1. This disclosure may refer to battery 106A and battery 106B collectively as “batteries 106.” This disclosure may refer to spacing elements 108A and spacing elements 108B collectively as “spacing elements 108.” This disclosure may refer to antenna 110A and antenna 110B collectively as “antennas 110.” Antenna 110B may be implemented in the same way as antenna 110A.

A coating 112A may be applied to components, such as battery 106A, spacing elements 108A, and antenna 110A. Coating 112A may be applied after assembly of the components but before introduction of the components into a housing of hearing instrument 102A. For example, battery 106A and antenna 110 may be installed on a spine 116A of hearing instrument 102A with one or more of spacing elements 108A between battery 106A and antenna 110A. In other words, spine 116A may hold antenna 110A and battery 106A. In this example, coating 112A may be applied, then this combination of components may be inserted into a shell or other type of housing. Coating 112A may be applied using a monomer vapor deposition process. In some examples, coating 112A is a parylene coating. Coating 112B of hearing instrument 102B is the same or similar to coating 112A.

Each of antennas 110 includes one or more antenna elements 114, e.g., antenna 110A includes at least antenna element 114A and antenna 110B includes at least antenna element 114B. An antenna element may be a radiating and/or receiving portion of the antenna. Antennas 110 may include multiple antenna elements. In some examples, one or more of antennas 110 may include a lateral antenna element and a medial antenna element. The lateral antenna element is on a lateral side of the hearing instrument and the medial antenna element is on a medial side of the hearing instrument. The medial side of the hearing instrument is closer to the head of the user than the lateral side of the head of the user when the user is wearing the hearing instrument. The lateral antenna element and the medial antenna element may be substantially parallel to one another. The battery (e.g., battery 106A or 106B) may be positioned between the first antenna element and the second antenna element. At least one spacing element (e.g., one or more of spacing elements 108A or spacing elements 108B) may be disposed between a lateral or medial end of the battery and the lateral or medial antenna element and/or a lateral or medial battery conductor. Thus, spacing elements 108 may act as spacers between the antenna element and the battery. The spacing elements may also be referred to herein as “antenna shims.” As described herein, spacing elements 108 may each have one of several profiles including, but not limited to, a disk-shaped profile, a rectangular profile, a square profile, a triangular profile, and so on.

In some examples, a maximum dimension (e.g., diameter, hypotenuse, length, etc.) of a spacing element is comparable to a diameter of the battery. For instance, the maximum dimension of the spacing element may be equal or substantially equal to the diameter of the battery. In other instances, the maximum dimension may be less than the diameter of the battery. In some examples, a maximum dimension of the spacing element may be comparable to a maximum dimension of an area of an antenna element that overlays the battery, whichever is less.

In some examples, a minimum thickness of spacing elements 108 is 10-20 thousandths of an inch in order to adequately provide spacing to counter the warping effect of the parylene coating.

In some examples, a minimum thickness of spacing elements 108 is on an order of 0.25-0.5 mm so that spacing elements 108 provide adequate spacing to counter the increasing width of batteries 106.

Spacing elements 108 may be positioned and oriented in different ways in different examples. In some examples, spacing elements 108 are positioned and oriented first to maximize a surface area coverage of a battery conductor. In other words, a spacing element may be oriented to maximize a surface area coverage of the battery conductor in an overlap region of the battery conductor and the antenna element. Additionally, spacing elements 108 may be positioned and oriented to maximize surface area coverage of the antenna conductor.

To address the increase of permittivity issue described above (i.e., coating 112 causing adhesion between antenna elements 114 and batteries 106 and thereby creating a layer of dielectric with higher permittivity), spacing elements 108 may be formed from materials with a dielectric constant less than 3, since 3 is the dielectric constant of the parylene material at 6 gigahertz (GHz). For example, spacing elements 108 may be formed from a plastic foam. Materials such as plastic foam which contain many air pockets may give a very low dielectric constant on the order of 1.0-1.2. Such plastic foams acceptable for use as spacing elements 108 may include but are not limited to: polystyrene foam, polyethylene foam, and polyurethane foam. To support both physical spacing and the permittivity objectives, spacing elements 108 may primarily comprise a low dielectric plastic foam with the edges lined with a stronger plastic. In other words, edge lines of the plastic foam are lined with a plastic having greater strength than the plastic foam. In this way, spacing elements 108 may achieve the low dielectric effect from the foam while still providing structural support for spacing between batteries 106 and antenna elements 114. In some examples, spacing elements 108 may comprise a rigid plastic foam, such as polyurethane, that may negate the need for supporting material around the edge of spacing elements 108. In some examples, one or more of spacing elements 108 is a hollow shell. In other words, a spacing element may include an enclosed air pocket surrounded on all sides by material, such as a plastic foam. A spacing element that encloses an air pocket may reduce the permittivity almost to a dielectric constant of air.

Hearing instruments 102 may include spines 116A, 116B (collectively, “spines 116”) that provide structural support for components of hearing instruments 102, such as batteries 106 and antennas 110. In some such examples, one or more of spacing elements 108 form portions of spines 116 or are otherwise mechanically connected to spines 116. Spacing elements 108 may be formed from the same material (e.g., a plastic or another material) as spines 116. Such spacing elements may reduce adhesion between antenna elements 114 and batteries 106 and may help to prevent warping of antenna elements 114. In some examples, an air gap remains between such spacing elements 108 and batteries 106, allowing coating 112 to coat batteries 106. In some examples, an air gap remains between such spacing elements 108 and antenna elements 114, allowing coating 112 to coat antenna elements 114. Spacing elements 108 may have a shape that allows for removal and replacement of batteries 106.

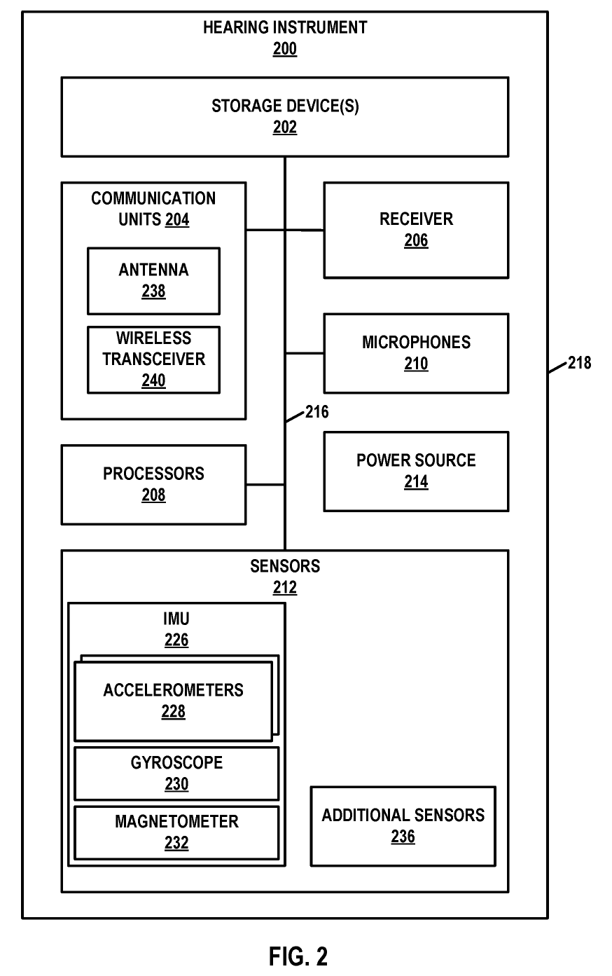

FIG. 2 is a block diagram illustrating example components of hearing instrument 200, in accordance with one or more aspects of this disclosure. Hearing instrument 200 may be either one of hearing instruments 102. Each of hearing instruments 102 may include the same components as hearing instrument 200.

In the example of FIG. 2, hearing instrument 200 comprises one or more storage devices 202, one or more communication units 204, a receiver 206, one or more processors 208, one or more microphones 210, a set of sensors 212, a power source 214, and one or more communication channels 216. Communication channels 216 provide communication between storage devices 202, communication units 204, receiver 206, processors 208, one or more microphones 210, and sensors 212. Storage devices 202, communication units 204, receiver 206, processors 208, microphones 210, and sensors 212 may draw electrical power from power source 214. In the example of FIG. 2, each of storage devices 202, communication units 204, receiver 206, processors 208, microphones 210, and sensors 212, power source 214, and communication channels 216 may be contained within a single housing 218. Power source 214 may be an example of one of batteries 106.

Furthermore, in the example of FIG. 2, sensors 212 include an inertial measurement unit (IMU) 226 that is configured to generate data regarding the motion of hearing instrument 200. IMU 226 may include a set of sensors. For instance, in the example of FIG. 2, IMU 226 includes one or more of accelerometers 228, a gyroscope 230, a magnetometer 232, combinations thereof, and/or other sensors for determining the motion of hearing instrument 200. Furthermore, in the example of FIG. 2, hearing instrument 200 may include one or more additional sensors 236. Additional sensors 236 may include a photoplethysmography (PPG) sensor, blood oximetry sensors, blood pressure sensors, electrocardiograph (EKG) sensors, body temperature sensors, electroencephalography (EEG) sensors, environmental temperature sensors, environmental pressure sensors, environmental humidity sensors, skin galvanic response sensors, and/or other types of sensors. In other examples, hearing instrument 200 and sensors 212 may include more, fewer, or different components.

Storage devices 202 may store data. Storage devices 202 may comprise volatile memory and may therefore not retain stored contents if powered off. Examples of volatile memories may include random access memories (RAM), dynamic random access memories (DRAM), static random access memories (SRAM), and other forms of volatile memories known in the art. Storage devices 202 may further be configured for long-term storage of information as non-volatile memory space and retain information after power on/off cycles. Examples of non-volatile memory configurations may include magnetic hard discs, optical discs, floppy discs, flash memories, or forms of electrically programmable memories (EPROM) or electrically erasable and programmable (EEPROM) memories.

Communication units 204 may enable hearing instrument 200 to send data to and receive data from one or more other devices, such as another hearing instrument, an accessory device, a mobile device, or another type of device. Communication units 204 may enable hearing instrument 200 to communicate using wireless or non-wireless communication technologies. For instance, communication units 204 enable hearing instrument 200 to communicate using one or more of various types of wireless technology, such as a BLUETOOTH™ technology, 3G, 4G, 4G Long Term Evolution (LTE), 5G, ZigBee, WI-FI™, Near-Field Magnetic Induction (NFMI), ultrasonic communication, infrared (IR) communication, or another wireless communication technology.

As shown in the example of FIG. 2, one or more of communication units 204 include an antenna 238 and a wireless transceiver 240. Antenna 238 may correspond to antenna 110A or 110B in FIG. 1. Wireless transceiver 240 may comprise circuitry configured to generate modulated electrical signals sent to antenna 238 and/or to process electrical signals received from antenna 238. Antenna 238 may be implemented in accordance with any of the example antenna designs described in this disclosure.

Receiver 206 comprises one or more speakers for generating audible sound. Microphones 210 detect incoming sound and generate one or more electrical signals (e.g., an analog or digital electrical signal) representing the incoming sound.

Processors 208 may be processing circuits configured to perform various activities. For example, processor(s) 208 may process the signal generated by microphones 210 to enhance, amplify, or cancel-out particular channels within the incoming sound. Processors 208 may then cause receiver 206 to generate sound based on the processed signal. In some examples, processors 208 include one or more digital signal processors (DSPs). In some examples, processors 208 may cause communication units 204 to transmit one or more of various types of data. For example, processors 208 may cause communication units 204 to transmit data to computing device 103. In some examples, processors 208 may cause communication units 204 to transmit data to another hearing instrument. Furthermore, communication units 204 may receive audio data from computing device 103 and processors 208 may cause receiver 206 to output sound based on the audio data.

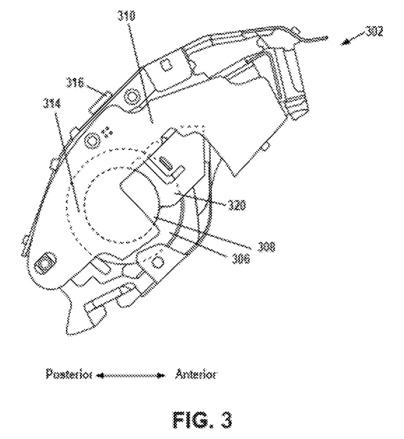

FIG. 3 is a conceptual diagram illustrating an example hearing instrument 302 with a disk-shaped spacing element 308, in accordance with one or more techniques of this disclosure. As shown in the example of FIG. 3, hearing instrument 302 includes an antenna 310 having an antenna element 314. Antenna element 314 may be a lateral or medial antenna element of antenna 310. A battery 306 of hearing instrument 302 is positioned within hearing instrument 302 at least partially behind antenna element 314 from the perspective of FIG. 3. Battery 306 may be a rechargeable battery or a removable, non-rechargeable battery. A battery conductor 320 electrically connects an end of battery 306 to one or more electronic components of hearing instrument 302. A spine 316 of hearing instrument 302 provides structural support for components of hearing instrument 302, including antenna 310 and battery 306.

Furthermore, spacing element 308 is positioned between antenna element 314 and an end of battery 306 (e.g., the terminal of battery 306) and/or battery conductor 320. A counterpart spacing element may be positioned on the other side of battery 306. Spacing element 308 has a disk-shaped profile. Spacing element 308 is centered on a terminal of battery 306. Centering spacing element 308 on the terminal of battery 306 may maximize coverage of battery conductor 320 in an overlap region of battery conductor 320 and antenna element 314 and maximize coverage of antenna element 314. In some examples, the diameter of spacing element 308 is equal to or approximately equal to the diameter of battery 306. In other examples, the diameter of spacing element 308 is less than the diameter of battery 306, providing an air gap between portions of spacing element 308 and battery 306.

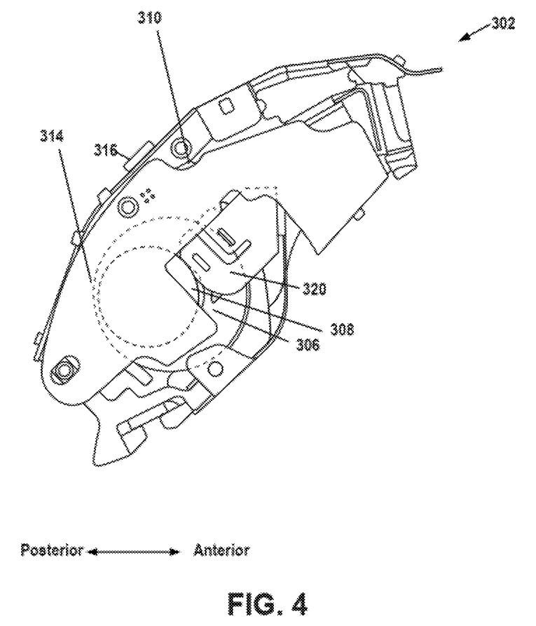

FIG. 4 is a conceptual diagram illustrating an example hearing instrument 302 with a disk-shaped spacing element 308, in accordance with one or more techniques of this disclosure. The example of FIG. 4 is similar to the example of FIG. 3 with the exception that spacing element 308 is located off-center relative to the terminal of battery 306 in a generally posterior direction. Positioning spacing element 308 on the terminal of battery 306 as shown in FIG. 4 may still maximize coverage of the battery conductor and maximize coverage of antenna element 314. In some examples, the diameter of spacing element 308 is equal to or approximately equal to the diameter of battery 306. In other examples, the diameter of spacing element 308 is less than the diameter of battery 306.

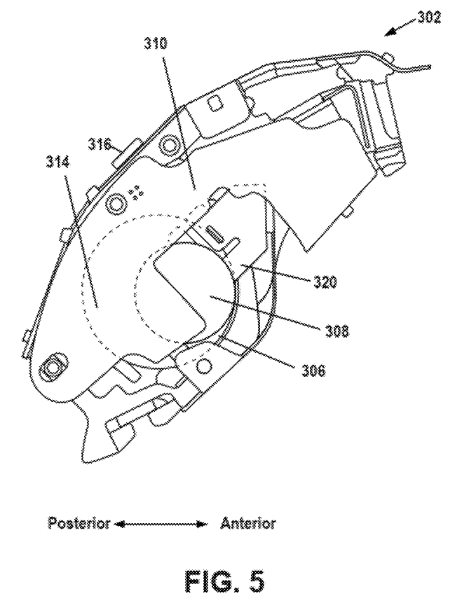

FIG. 5 is a conceptual diagram illustrating an example hearing instrument 302 with a disk-shaped spacing element 308, in accordance with one or more techniques of this disclosure. The example of FIG. 5 is similar to the examples of FIGS. 3, and 4 with the exception that spacing element 308 is located off-center of the terminal of battery 306 in a generally anterior direction. However, in the example of FIG. 5, spacing element 308 may not maximize coverage of antenna element 314. In other words, there is additional open air space between antenna element 314 and battery 306, which may allow for increased adhesion of antenna element 314 and battery 306 and/or warping of antenna element 314.

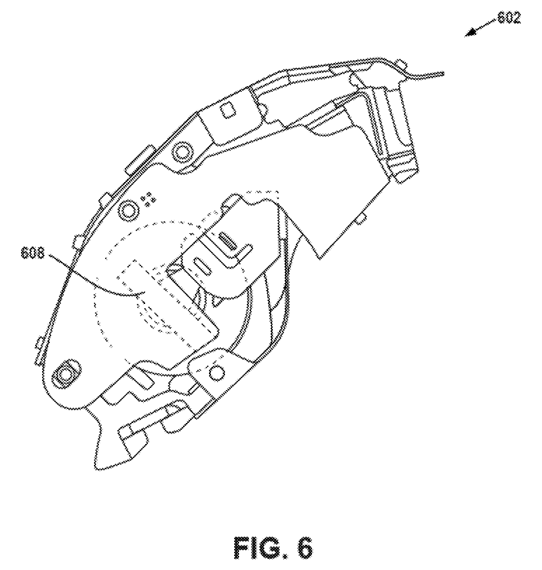

FIG. 6 is a conceptual diagram illustrating an example hearing instrument 602 with a rectangular spacing element 608, in accordance with one or more techniques of this disclosure. Hearing instrument 602 is similar to hearing instrument 302 (FIGS. 3-5) with the exception that spacing element 608 is rectangular instead of round.

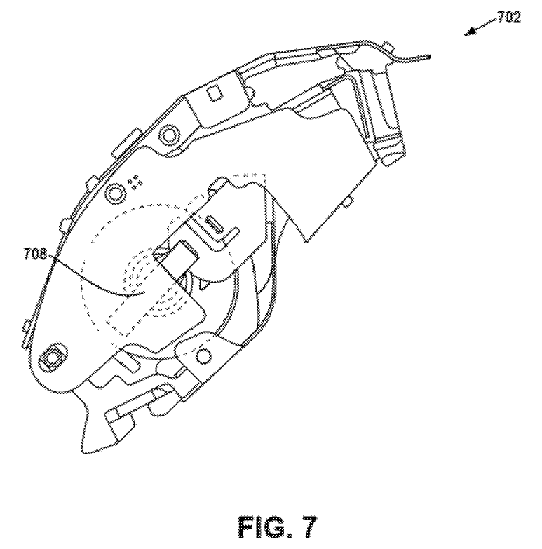

FIG. 7 is a conceptual diagram illustrating an example hearing instrument 702 with a rectangular spacing element 708, in accordance with one or more techniques of this disclosure. Hearing instrument 702 is similar to hearing instrument 602 (FIG. 6) with the exception that spacing element 708 is oriented in a different direction from spacing element 608.

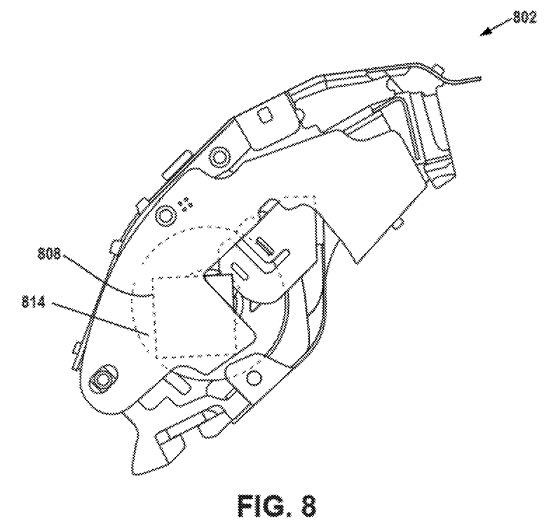

FIG. 8 is a conceptual diagram illustrating an example hearing instrument 802 with a square spacing element 808, in accordance with one or more techniques of this disclosure. Hearing instrument 802 is similar to hearing instrument 302 (FIGS. 3-5) with the exception that spacing element 808 is square instead of round.

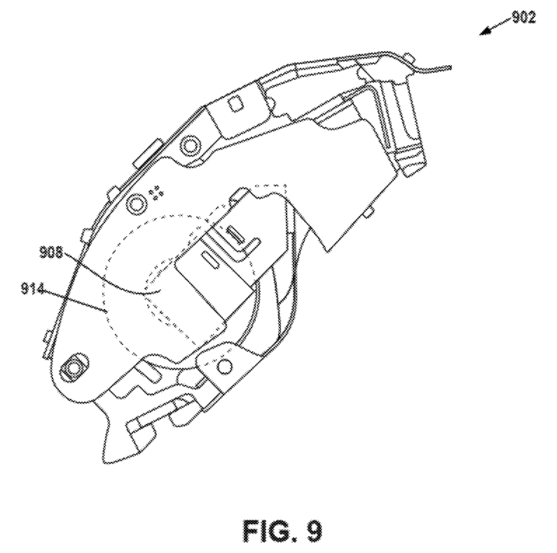

FIG. 9 is a conceptual diagram illustrating an example hearing instrument 902 with a square spacing element 908, in accordance with one or more techniques of this disclosure. Hearing instrument 902 is similar to hearing instrument 802 (FIG. 8) with the exception that spacing element 908 is at a different position than spacing element 808. The position of spacing element 908 may be less advantageous than the position of spacing element 808 since the position of spacing element 908 does not maximize coverage of an antenna element 914. Thus, antenna element 914 may be more prone to adhesion or warping than antenna element 814.

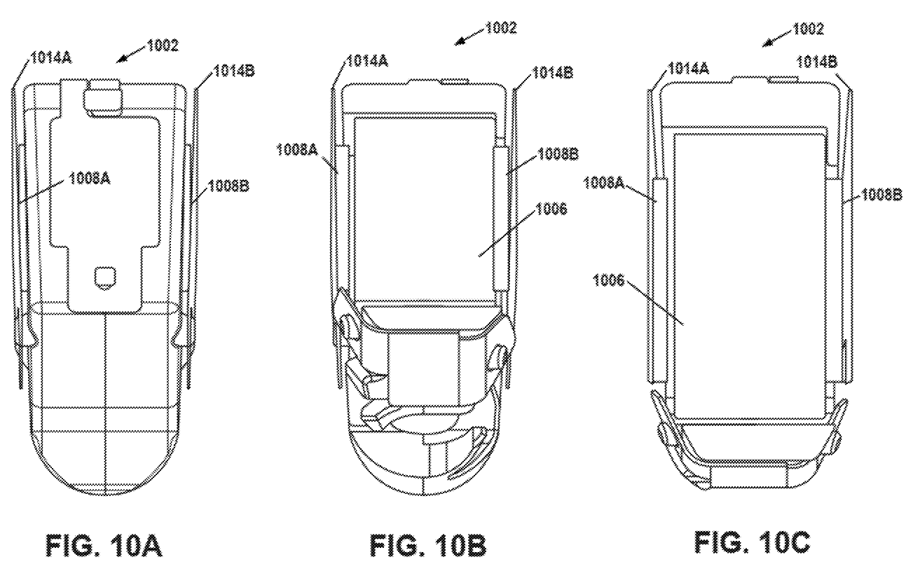

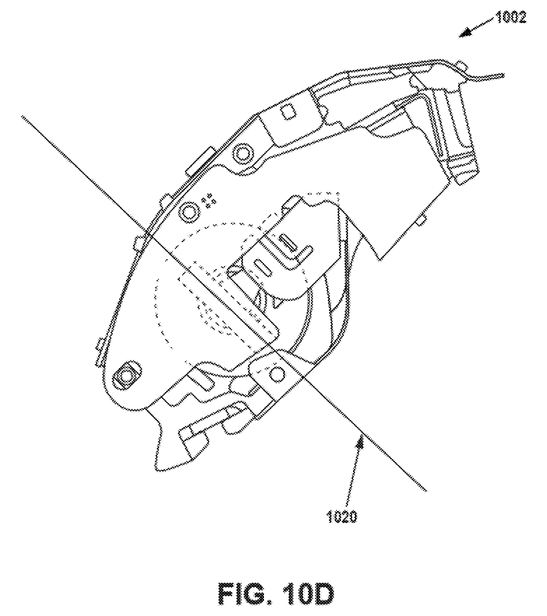

FIGS. 10A, 10B, 10C illustrate example views of a hearing instrument 1002 in accordance with one or more techniques of this disclosure. FIG. 10D illustrates a cross-section plane 1020 applied with respect to FIG. 10C. FIG. 10A shows hearing instrument 1002 from a generally superior to inferior perspective. FIG. 10B shows hearing instrument 1002 from a generally inferior to superior perspective. FIG. 10C shows a cross-section of hearing instrument 1002 sliced along cross-section plane 1020. Hearing instrument 1002 includes a medial antenna element 1014A and a lateral antenna element 1014B. Additionally, hearing instrument 1002 includes a medial spacing element 1008A and a lateral spacing element 1008B. Medial spacing element 1008A is disposed between at least one of: medial antenna element 1014A and a battery conductor connected to an end of battery 1006.

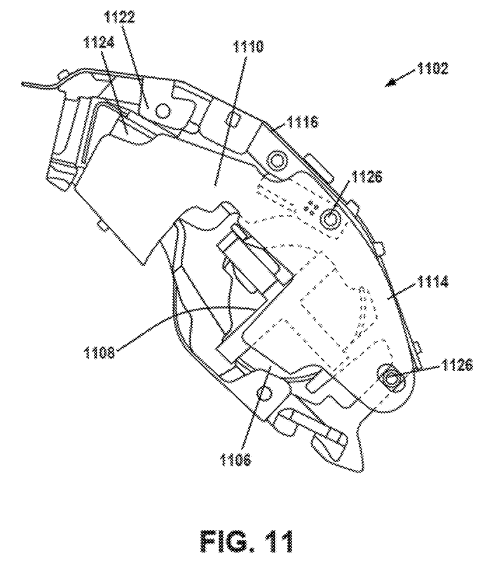

FIG. 11 is a conceptual diagram illustrating an example hearing instrument 1102 with an X-shaped spine spacing element, in accordance with one or more techniques of this disclosure. In the example of FIG. 11, hearing instrument 1102 includes a spine 1116. Spine 1116 acts as a scaffold to hold various components of hearing instrument 1102 in position relative to one another. For instance, spine 1116 may define a first cavity that retains battery 1106, a support structure 1122 attached to spine 1116 may retain a receiver 1124, and so on. Additionally, spine 1116 may have protrusions 1126 which may help to maintain the position of an antenna 1110. Spine 1116 may be made of plastic or another material. Spine 1116 may be rigid.

Spine 1116 includes a spacing element 1108 that is positioned between battery 1106 and an antenna element 1114. In the example of FIG. 11, spacing element 1108 is generally X-shaped. Spacing element 1108 may prevent antenna element 1114 from adhering to battery 1106 or warping in the direction of battery 1106 after application of the coating. In some examples, spacing element 1108 is an integral part of spine 1116. In some examples, spacing element 1108 is fixedly attached to spine 1116. In some examples, spacing element 1108 is detachable from spine 1116. For instance, a person may detach spacing element 1108 from spine 1116 for purposes of replacing battery 1106. In some examples, spacing element 1108 may be hinged or may be deformable to allow replacement of battery 1106. In any example, spacing element 1108 may be mechanically coupled to spine 1116. Including the spacing element in the spine may increase rigidity.

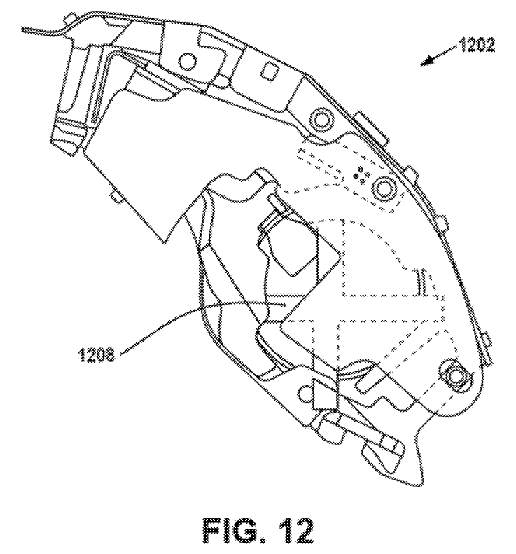

FIG. 12 is a conceptual diagram illustrating an example hearing instrument 1202 with a second X-shaped spine spacing element, in accordance with one or more techniques of this disclosure. Hearing instrument 1202 is similar to hearing instrument 1102 with the exception that spacing element 1208 is rotated relative to spacing element 1108.

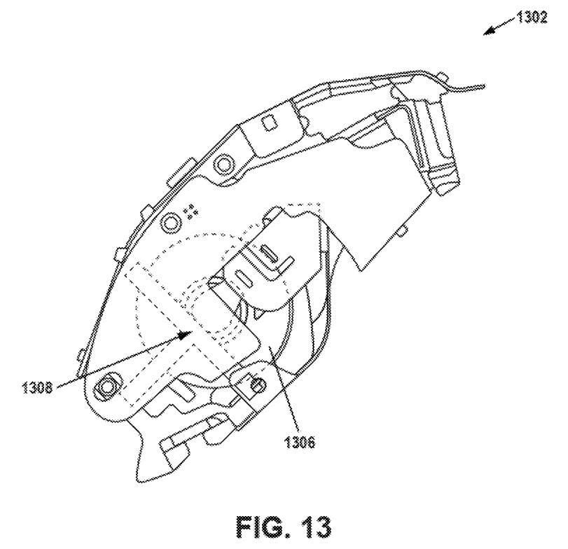

FIG. 13 is a conceptual diagram illustrating an example hearing instrument 1302 with a T-shaped spine spacing element 1308, in accordance with one or more techniques of this disclosure. Hearing instrument 1302 is similar to hearing instrument 1102 and 1202 with the exception that spacing element 1308 is T-shaped instead of X-shaped. The T-shape of spacing element 1308 may potentially allow for easy access to battery 1306 for replacement of battery 1306.

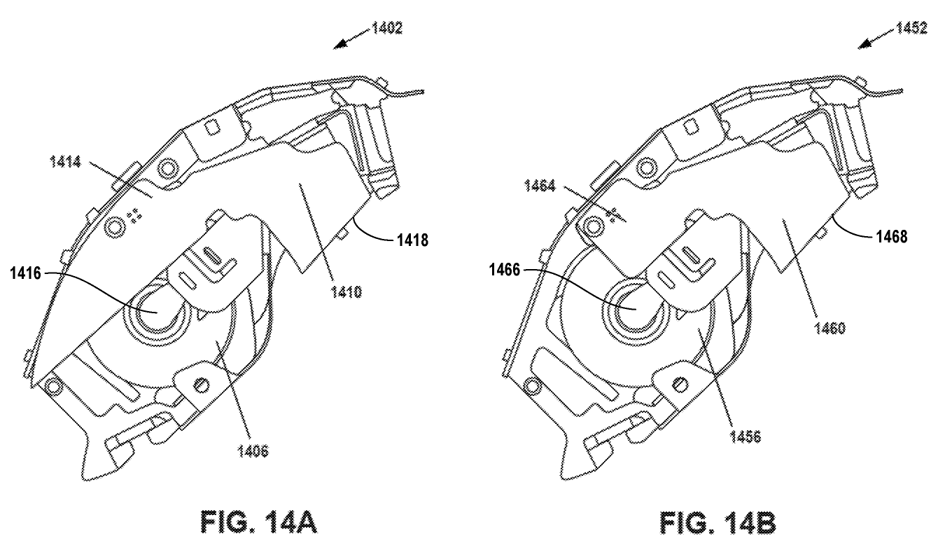

FIG. 14A is a conceptual diagram illustrating an example hearing instrument 1402 with a reduced overlap between an antenna element and a battery, in accordance with one or more techniques of this disclosure. In the example of FIG. 14A, hearing instrument 1402 includes an antenna 1410 having an antenna element 1414. An area of overlap between antenna element 1414 and battery 1406 is reduced relative to antenna elements shown in other examples of this disclosure. Reducing the surface area of antenna element 1414 in this way may reduce capacitive loading on antenna element 1414. Although not shown in the example of FIG. 14A, one or more spacing elements may, in some examples, be positioned between antenna element 1414 and battery 1406. In some examples, the reduction in surface area of antenna element 1414 may be sufficient to reduce or eliminate the need for spacing elements. As shown in the example of FIG. 14A, antenna 1410 may overlap a semi-circular area of battery 1406 that occupies less than one third of the area of the end of the battery 1406. Antenna 1410 does not overlap any of antenna conductor 1416.

In the example of FIG. 14A, antenna 1410 may be a bowtie antenna with a strap element 1418 in which the bowtie length is greatly reduced such that the length to width ratio is less than one. Strap element 1418 connects antenna element 1414 with a corresponding antenna element on the opposite side of hearing instrument 1402. Antenna 1410 may reduce the copper area over the battery conductor, thus reducing the capacitive coupling to battery 1406. Additionally, antenna 1410 may have other advantages over the bowtie with strap antennas that cover more area of the battery. In comparison to such antennas, the radiation efficiency of antenna 1410 is improved for on-head radiation while reducing mismatch loss.

FIG. 14B is a conceptual diagram illustrating an example hearing instrument 1452 with a reduced overlap between an antenna element and a battery, in accordance with one or more techniques of this disclosure. In the example of FIG. 14B, hearing instrument 1452 includes an antenna 1460 having an antenna element 1464. An area of overlap between antenna element 1464 and battery 1456 is reduced relative to antenna elements shown in other examples of this disclosure. Reducing the surface area of antenna element 1464 in this way may reduce capacitive loading on antenna element 1464. Although not shown in the example of FIG. 14B, one or more spacing elements may, in some examples, be positioned between antenna element 1464 and battery 1456. In some examples, the reduction in surface area of antenna element 1464 may be sufficient to reduce or eliminate the need for spacing elements. As shown in the example of FIG. 14B, antenna 1460 may overlap a sector of battery 1456 that occupies less than one quarter of the area of the end of the battery 1456. Antenna 1460 does not overlap any of antenna conductor 1466.

Antenna 1460 may be a loop antenna, referred to here as a “strap” antenna. Antenna 1460 includes a strap element 1468 that connects antenna element 1464 with a corresponding antenna element on the opposite side of hearing instrument 1452. Feedlines of antenna 1452 may be soldered to one another, thereby forming a loop. This strap antenna reduces the copper area over the battery conductor, thus reducing the capacitive coupling to the battery. Additionally, antenna 1460 may have other advantages over the traditional bowtie with strap antenna that cover greater areas of the battery. For instance, antenna 1460 may maintain the radiation efficiency of such antennas despite reduction of copper. However, the mismatch loss may be improved with antenna 1460 as compared to such antennas. Therefore, in addition to reducing the capacitive coupling to the battery, antenna 1460 may reduce mismatch loss when matching to the human body.

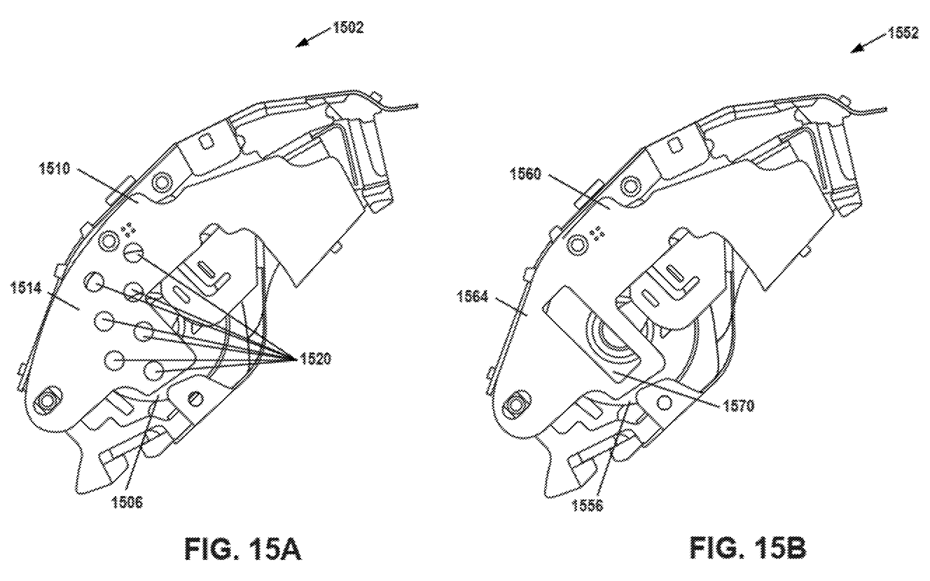

FIG. 15A is a conceptual diagram illustrating an example hearing instrument 1502 with a perforated antenna element, in accordance with one or more techniques of this disclosure. In the example of FIG. 15A, hearing instrument 1502 includes an antenna 1510 having an antenna element 1514. Antenna element 1514 defines a set of perforations 1520. Perforations 1520 may reduce a surface area of antenna element 1514 positioned over battery 1506 relative to a surface area of antenna element 1514 devoid of perforations 1520. Reducing the surface area of antenna element 1514 in this way may reduce capacitive loading on antenna element 1514 due to battery 1506. Although not shown in the example of FIG. 15A, one or more spacing elements may, in some examples, be positioned between antenna element 1514 and battery 1506. In some examples, the reduction in surface area of antenna element 1514 may be sufficient to reduce or eliminate the need for spacing elements.

FIG. 15B is a conceptual diagram illustrating an example hearing instrument 1552 in which an antenna element defines a window, in accordance with one or more techniques of this disclosure. In the example of FIG. 15B, hearing instrument 1552 includes an antenna 1560 having an antenna element 1564. Antenna element 1564 defines an opening 1570. Opening 1570 may reduce a surface area of antenna element 1564 positioned over battery 1556 relative to a surface area of antenna element 1564 devoid of opening 1570. Reducing the surface area of antenna element 1564 in this way may reduce capacitive loading on antenna element 1564 due to battery 1556. Although not shown in the example of FIG. 15B, one or more spacing elements may, in some examples, be positioned between antenna element 1564 and battery 1556. In some examples, the reduction in surface area of antenna element 1564 may be sufficient to reduce or eliminate the need for spacing elements. Thus, in the examples of FIGS. 15A, and 15B, a hearing instrument may include an antenna element that defines one or more perforations or windows that reduce a capacitive loading of the antenna element relative to the antenna element devoid of the perforations or the windows.

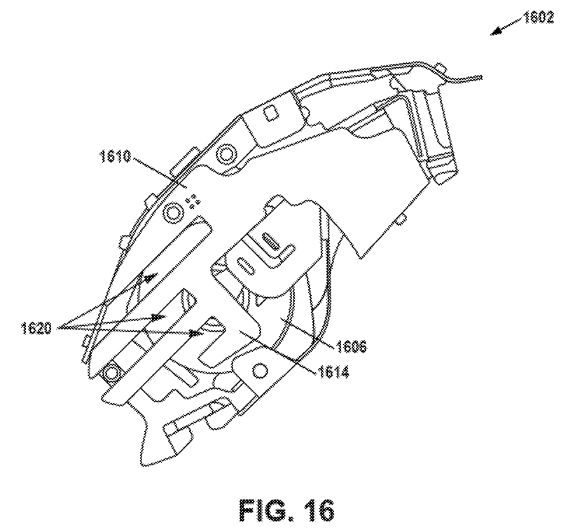

FIG. 16 is a conceptual diagram illustrating an example hearing instrument 1602 in which an antenna element 1614 of an antenna 1610 defines digitated slots 1620, in accordance with one or more techniques of this disclosure. Slots 1620 extend from an edge of antenna 1610. Slots 1620 may reduce a surface area of antenna element 1614 positioned over battery 1606 relative to a surface area of antenna element 1614 devoid of slots 1620. Reducing the surface area of antenna element 1614 may reduce capacitive loading on antenna element 1614. Furthermore, slots 1620 may avoid coverage of specific areas of battery 1606. Although not shown in the example of FIG. 16, one or more spacing elements may, in some examples, be positioned between antenna element 1614 and battery 1606. In some examples, the reduction in surface area of antenna element 1614 may be sufficient to reduce or eliminate the need for spacing elements.

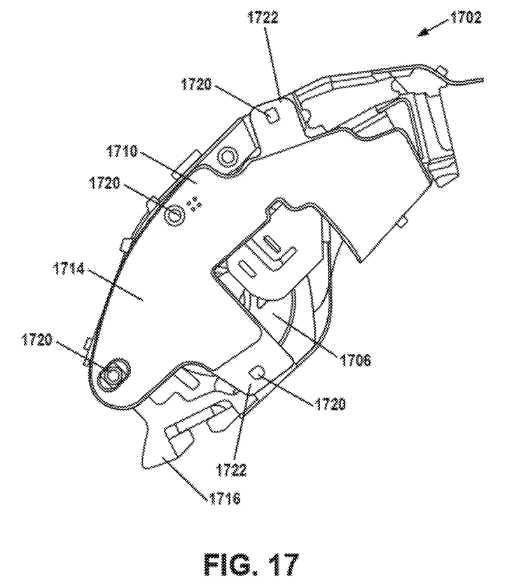

FIG. 17 is a conceptual diagram illustrating an example hearing instrument 1702 in which protrusions 1720 of a spine 1716 are used to support an antenna element 1714, in accordance with one or more techniques of this disclosure. In the example of FIG. 17, spine 1716 has one or more protrusions 1720. One or more portions of antenna 1710 may be backed and/or outlined by a support structure 1722. Support structure 1722 may be formed of a polyimide material, polyimide and copper, or another type of material or combination of types of materials. In some examples, support structure 1722 has one or more openings that engage with respective protrusions 1720 of spine 1716. When the openings of support structure 1722 are engaged with the respective protrusions 1720, there may be tension within support structure 1722 or inward deflection of antenna element 1714 toward battery 1706 would cause tension within support structure 1722. In either case, such tension within support structure 1722 may reduce or prevent the inward deflection of antenna element 1714 toward battery 1706. Although not shown in the example of FIG. 17, one or more spacing elements may, in some examples, be positioned between antenna element 1714 and battery 1706. In some examples, the tension within support structure 1722 may reduce or eliminate the need for spacing elements.

Thus, in the example of FIG. 17, hearing instrument 1702 may comprise a spine 1716 having two or more protrusions 1720 and a support structure 1722 that backs or outlines at least some of an antenna element 1714, wherein support structure 1722 defines two or more openings that engage the one or more protrusions 1720. Support structure 1722 may be held in tension between the two or more protrusions 1720.

In any of the examples of FIGS. 3-9 and 11-17, structures of the hearing instrument, such as antenna elements and spacing elements may have the same or different shapes on the opposite side from that shown in FIGS. 3-9 and 11-17.

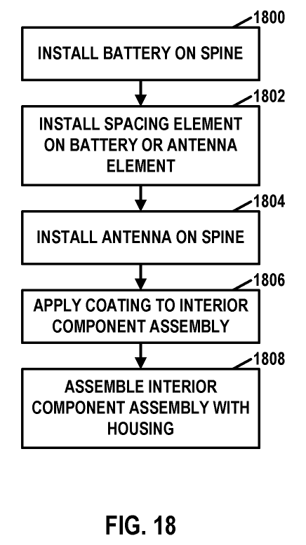

FIG. 18 is a flowchart of an example process for assembling a hearing instrument, in accordance with one or more techniques of this disclosure. FIG. 18 is described with respect to hearing instrument 102A but may be applicable with respect to other hearing instruments described in this disclosure. The process of assembling the hearing instrument may include more steps than shown in the example of FIG. 18.

In the example of FIG. 18, an assembler may install battery 106A on a spine (1800). The assembler may be one or more humans and/or one or more robots. The assembler may also install other components of hearing instrument 102A on the spine, such as a receiver, microphones, one or more circuit boards (which may include processors, storage devices, wireless transceivers, charging circuitry, etc.), sensors, and so on.

Additionally, the assembler may install one or more spacing elements 108A on a surface of battery 106A or on a surface of an antenna element of antenna 110A (1802). In some examples, an adhesive is applied to one or more surfaces of spacing elements 108A so that spacing elements 108A stick to the surface of battery 106A, a battery conductor, and/or the antenna or antenna element. Thus, a spacing element may be adhered to an end of the battery and/or a battery conductor.

The assembler may then install antenna 110Aon the spine (1804). In some examples, the spine has protrusions that correspond to openings in antenna 110A. The assembler manipulates antenna 110A such that the protrusions extend through the openings in antenna 110A. The assembler may then deposit a glue, resin, acrylic, or other substance over the protrusions to secure antenna 110A to the spine.

After antenna 110A is installed, the assembler may apply a coating (e.g., a parylene coating) to an interior component assembly (1806). The interior component assembly is an assembly of the spine and components (e.g., battery 106A, spacing elements 108A, antenna 110A, etc.) connected directly or indirectly to the spine. In this way, the spine and the components connected directly or indirectly to the spine are coated with the coating.

Subsequently, the assembler may assemble the interior component assembly with a housing (1808). For example, the assembler may insert the interior component assembly into a custom or standardized shell and install a faceplate over an opening of the shell. In another example, the assembler may connect two or more housing components to each other so as to surround the interior component assembly.

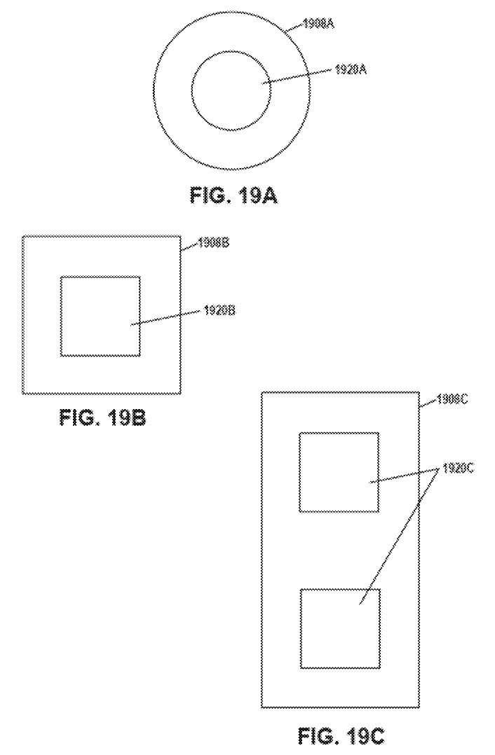

FIGS. 19A, 19B, and 19C are conceptual diagrams illustrating example spacing elements that define one or more enclosed openings. Specifically, FIG. 19A illustrates an example circular spacing element 1908A. Spacing element 1908A defines an opening 1920A. FIG. 19B illustrates an example square spacing element 1908B. Spacing element 1908B defines an opening 1920B. FIG. 19C illustrates an example rectangular spacing element 1908C. Spacing element 1908C defines openings 1920C. This disclosure may refer to openings 1920A, 1920B, and 1920C collectively as “openings 1920.” In other examples, spacing elements may have different numbers of openings and/or differently shaped openings than those shown in FIGS. 19A, 19B, and 19C. Openings 1920 may assist with manufacturability of hearing instruments in that openings 1920 may make it easier to grasp spacing elements 1908 or may accommodate protrusions of one or more components.

As noted above, a spacing element may be a hollow shell. In other words, the spacing element may include an enclosed air pocket surrounded on all sides by material, such as a plastic foam. Thus, in such examples, instead of opening 1920A of spacing element 1908A being open on either end, both ends of opening 1920A may be closed and opening 1920A may be a hollow air pocket. Similar considerations may apply with respect to openings 1920B and 1920C of spacing elements 1908B and 1908C, respectively.

With reference to antennas, “superior” and “inferior” correspond to opposite directions on an axis. The superior direction of the axis is generally upward when a hearing instrument that includes the antenna is worn and the inferior direction of the axis is generally downward when the hearing instrument is worn and the user is standing erect. However, the axis is not necessarily straight up or down relative to the transverse axis of the user’s body.

Examples of the various aspects of this disclosure may be used individually or in any combination. Additional aspects of the disclosure are detailed in numbered clauses below.
Clause 1. A hearing instrument comprising a battery that is substantially cylindrical and has a first end and a second end, an antenna comprising an antenna element, a spacing element disposed between the antenna element and at least one of the first end of the battery or a battery conductor connected to the first end of the battery, and a conformal coating that covers exposed surfaces of the antenna element, the spacing element, and the battery, wherein an air gap is present between at least a portion of the spacing element and the first end of the battery facing the antenna element.
Clause 2. The hearing instrument of Clause 1, wherein the hearing instrument further comprises a spine that holds the antenna and the battery, and the hearing instrument further comprises a second spacing element that is an integral part of the spine or fixedly attached to the spine.
Clause 3. The hearing instrument of Clause 2, wherein the second spacing element is formed from a same material as the spine.
Clause 4. The hearing instrument of any of Clauses 1-3, wherein the spacing element comprises a material having a dielectric constant less than 3.
Clause 5. The hearing instrument of any of Clauses 1-4, wherein the hearing instrument comprises one or more electronic components and the battery conductor, the battery conductor electrically connects the first end of the battery to the one or more electronic components, and the spacing element is oriented to maximize a surface area coverage of the battery conductor in an overlap region of the battery conductor and the antenna element.
Clause 6. The hearing instrument of any of Clauses 1-5, wherein the spacing element comprises a plastic foam.
Clause 7. The hearing instrument of Clause 6, wherein edge lines of the plastic foam are lined with a plastic having greater strength than the plastic foam.
Clause 8. The hearing instrument of any of Clauses 1-7, wherein the antenna element defines one or more perforations or windows that reduce a capacitive loading of the antenna element relative to the antenna element devoid of the perforations or the windows.
Clause 9. The hearing instrument of any of Clauses 1-8, wherein the hearing instrument further comprises a spine having two or more protrusions, and a support structure that backs or outlines at least some of the antenna element, wherein the support structure defines two or more openings that engage the one or more protrusions, wherein the support structure is held in tension between the two or more protrusions.
Clause 10. The hearing instrument of any of Clauses 1-9, wherein the antenna element defines one or more slots extending from an edge of the antenna.
Clause 11. The hearing instrument of any of Clauses 1-10, wherein the antenna element is a lateral antenna element and the spacing element is a lateral spacing element, the antenna further comprises a medial antenna element, wherein the lateral antenna element is on a lateral side of the hearing instrument and the medial antenna element is on a medial side of the hearing instrument, the lateral antenna element and the medial antenna element are substantially parallel to one another, the battery is positioned between the lateral antenna element and the medial antenna element, and a medial spacing element is disposed between at least one of the medial antenna element and a second battery conductor connected to the second end of the battery.
Clause 12. The hearing instrument of any of Clauses 1-11, wherein the spacing element is adhered to the first end of the battery.
Clause 13. The hearing instrument of any of Clauses 1-12, wherein the spacing element defines one or more enclosed openings.
Clause 14. The hearing instrument of any of Clauses 1-13, wherein a thickness of the spacing element is 0.25-0.5 mm.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations.

It is to be recognized that depending on the example, certain acts or events of any of the features or techniques described herein can be created, assembled, or performed in a different sequence, may be added, merged, or left out altogether (e.g., not all described acts or events are necessary for the practice of the techniques). For instance, this disclosure describes various examples of an antenna; these examples may be used individually or in combination. Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, read-only memory (ROM), EEPROM, compact disc read-only memory (CD-ROM) or other optical disk storage, magnetic disk storage, or other magnetic storage devices, flash memory, cache memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A hearing instrument comprising:
a battery that is substantially cylindrical and has a first end and a second end;
an antenna comprising an antenna element;
a spacing element disposed between the antenna element and at least one of: the first end of the battery or a battery conductor connected to the first end of the battery; and
a conformal coating that covers exposed surfaces of the antenna element, the spacing element, and the battery, wherein an air gap is present between at least a portion of the spacing element and the first end of the battery facing the antenna element.

2. The hearing instrument of claim 1, wherein:
the hearing instrument further comprises a spine that holds the antenna and the battery, and
the hearing instrument further comprises a second spacing element that is an integral part of the spine or fixedly attached to the spine.

3. The hearing instrument of claim 2, wherein the second spacing element is formed from a same material as the spine.

4. The hearing instrument of claim 1, wherein the spacing element comprises a material having a dielectric constant less than 3.

5. The hearing instrument of claim 1, wherein:
the hearing instrument comprises one or more electronic components and the battery conductor, the battery conductor electrically connects the first end of the battery to the one or more electronic components, and
the spacing element is oriented to maximize a surface area coverage of the battery conductor in an overlap region of the battery conductor and the antenna element.

6. The hearing instrument of claim 1, wherein the spacing element comprises a plastic foam.

7. The hearing instrument of claim 6, wherein edge lines of the plastic foam are lined with a plastic having greater strength than the plastic foam.

8. The hearing instrument of claim 1, wherein the antenna element defines one or more perforations or windows that reduce a capacitive loading of the antenna element relative to the antenna element devoid of the perforations or the windows.

9. The hearing instrument of claim 1, wherein:
the hearing instrument further comprises:
a spine having two or more protrusions, and
a support structure that backs or outlines at least some of the antenna element, wherein the support structure defines two or more openings that engage the one or more protrusions, wherein the support structure is held in tension between the two or more protrusions.

10. The hearing instrument of claim 1, wherein the antenna element defines one or more slots extending from an edge of the antenna.

11. The hearing instrument of claim 1, wherein:
the antenna element is a lateral antenna element and the spacing element is a lateral spacing element,
the antenna further comprises:
a medial antenna element, wherein the lateral antenna element is on a lateral side of the hearing instrument and the medial antenna element is on a medial side of the hearing instrument, the lateral antenna element and the medial antenna element are substantially parallel to one another, the battery is positioned between the lateral antenna element and the medial antenna element, and
a medial spacing element disposed between at least one of: the medial antenna element and a second battery conductor connected to the second end of the battery.

12. The hearing instrument of claim 1, wherein the spacing element is adhered to the first end of the battery.

13. The hearing instrument of claim 1, wherein the spacing element is adhered to the antenna.

14. The hearing instrument of claim 1, wherein the spacing element defines one or more enclosed openings.

15. The hearing instrument of claim 1, wherein a thickness of the spacing element is 0.25-0.5 mm.
